(19) United States
(12) Patent Application Publication
(10) Pub. No.: US 2005/0202106 A1
(43) Pub. Date: Sep. 15, 2005

(54) Mosquito repellent compositions

(76) Inventor: Russell R. Friedrikis, Bessemer, AL (US)

Correspondence Address: BAKER, DONELSON, BEARMAN,;CALDWELL & BERKOWITZ, P.C., 5 CONCOURSE PARKWAY, STE. #900, ATLANTA, GA, 30328, US

(21) Appl. No.: 11/074,986

(22) Filed: Mar. 8, 2005

Related U.S. Application Data
(60) Provisional application No. 60/551,645, filed on Mar. 9, 2004.

(51) Int. Cl. A01N 65/00

(52) U.S. Cl. 424/739; 424/747; 424/745

(57) ABSTRACT

Mosquito repellent compositions are provided which can be in the form of a lozenge, a chewing gum or a sucker. These compositions are primarily organic, non-toxic, sugar-free and are comprised of natural components.

This non-provisional application claims the benefit of U.S. Provisional Application Ser. No. 60/551,645, filed Mar. 9, 2004.

### TECHNICAL FIELD

The present invention relates to mosquito repellent compositions. The present invention also relates to a process for repelling mosquitos.

### BACKGROUND OF THE INVENTION

As is well known today, the mosquito is an insect which, depending on conditions of temperatures and humidity, can be very irritating to humans. Mosquitoes have the ability to disrupt or even ruin outdoor events, such as parties, family outings, etc.

In addition to being irritating, mosquitoes can be dangerous to humans, as mosquitoes can carry and transmit diseases, such as West Nile Virus and Equine Encephalitis. Clearly, some of these diseases can potentially be life-threatening to humans and, therefore, mosquitoes are a national health concern.

Studies have shown that mosquitoes are attracted to humans in several ways, such as the attraction of carbon dioxide in a person's breath, body odor or body heat. The carbon dioxide attracts the mosquito, which lands on the person's skin and then proceeds to bite.

As a result of the desire to avoid mosquitoes, many methods and compositions have been developed to repel mosquitoes. One popular repellent composition is DEET, or diethyl toluamide (C₁₂H₁₇N₀), which is applied to a person's skin. However, in recent years, environmental concerns have been raised about the use of this composition.

Therefore, a continuing need exists for an effective mosquito repellent composition which avoids environmental concerns.

### SUMMARY OF THE INVENTION

Briefly described, the present invention provides compositions which are effective to repel mosquitoes and which avoid environmental concerns. The mosquito repellent compositions of this invention are comprised of maltitol compounds, peppermint oil, cinnamon oil and nepetalactone oil. One or more maltitol compounds can be used in these compositions.

The mosquito repellent compositions of this invention can be provided in different forms, preferably in the form of a lozenge, a chewing gum or a sucker.

The compositions of this invention are non-toxic and avoid environmental concerns.

Accordingly, an object of this invention is to provide a mosquito repellent composition.

Another object of this invention is to provide a mosquito repellent composition which is safe for use by humans.

Another object of this invention is to provide a mosquito repellent composition which avoids environmental concerns.

Still another object of this invention is to provide a mosquito repellent composition in the form of a lozenge.

Still another object of this invention is to provide a mosquito repellent composition in the form of a chewing gum.

Still another object of this invention is to provide a form of a sucker.

These and other objects, features and advantages of this invention will become apparent from the following detailed description.

### DETAILED DESCRIPTION OF THE INVENTION

The present invention provides new and unique mosquito repellent compositions which are comprised of the following four essential components: (1) one or more maltitol compounds, (2) peppermint oil, (3) cinnamon oil and (4) nepetalactone oil.

This composition, which is preferably provided in the form of a lozenge, a chewing gum or a sucker, is primarily an organic, non-toxic, sugar-free composition of natural components.

While not fully understood, the repellent compositions of the present invention are believed (a) to “coat” a user's breath in such a way as to render the carbon dioxide exhalant a non-attractant for mosquitoes. Additionally, the repellent compositions are believed to accumulate in a user's sweat glands and then are released through perspiration to render the carbon dioxide epidermal respiration a non-attractant for mosquitoes.

The four essential components of a preferred repellent composition are present as follows:

| Component | Parts by Weight |
|---|---|
| Maltitol Component | 1.0-4.0 |
| Peppermint Oil | .01-.03 |
| Cinnamon Oil | .01-.03 |
| Nepetalactone Oil | .001-.01 |

In the above formulation, the maltitol component can be in one or more forms, such as syrup and granular, and the nepetalactone oil preferably has a purity of at least about 76%. Each of the three oils is an active component, with the maltitol component (also a non-attractant to mosquitoes) providing form and consistency to the repellent composition.

Preferably, natural strains of the peppermint, cinnamon and nepetalactone oils are used. For example, these natural strains would be menta piperita for the peppermint oil; cinnamonmum cassia for the cinnamon oil; and nepeta cataria for the nepetalactone oil.

A preferred mosquito repellent composition according to this invention is as follows:

| Component | Parts by Weight |
|---|---|
| Maltitol Syrup | 1.5 |
| Maltitol Granular | 1.0 |
| Peppermint Oil | 0.014 |
| Cinnamon Oil | 0.016 |
| 76% Nepetalactone Oil | 0.005 |

Optional components can be added to these repellent compositions to achieve various effects. Examples of such optional components are dyes, colorants, stabilizers, vitamins, thickeners, fillers, etc.

The compositions of this invention have been tested and found to be effective for use by humans in repelling mosquitoes.

This invention has been described in detail with particular reference to certain embodiments, but variations and modifications can be made without departing from the spirit and scope of the invention.

1. A mosquito repellent composition which comprises the following components:
(a) at least one maltitol compound;
(b) peppermint oil;
(c) cinnamon oil; and
(d) nepetalaclone oil.

2. A mosquito repellent composition as defined by claim 1 wherein the composition comprises from about 1.0 to about 4.0 parts by weight of the maltitol component.

3. A mosquito repellent composition as defined by claim 1 wherein the composition comprises from about 0.01 to about 0.03 parts by weight of the peppermint oil component.

4. A mosquito repellent composition as defined by claim 1 wherein the composition comprises from about 0.01 to about 0.03 parts by weight of the cinnamon oil component.

5. A mosquito repellent composition as defined by claim 1 wherein the composition from about 0.001 to about 0.01 parts by weight of the nepetalactone oil component.

6. A process for repelling mosquitoes which comprises treating human skin with a composition which comprises the following components:
(a) at least one maltitol compound;
(b) peppermint oil;
(c) cinnamon oil; and
(d) nepetalaclone oil.

7. A process as defined by claim 6 wherein the composition comprises from about 1.0 to about 4.0 parts by weight of the maltitol component.

8. A process as defined by claim 6 wherein the composition comprises from about 0.01 to about 0.03 parts by weight of the peppermint oil component.

9. A process as defined by claim 6 wherein the composition comprises from about 0.01 to about 0.03 parts by weight of the cinnamon oil component.

10. A process as defined by claim 6 wherein the composition comprises from about 0.001 to about 0.01 parts by weight of the nepetalactone oil component.
